(19) United States
(12) Patent Application Publication
(10) Pub. No.: US 2010/0207743 A1
(43) Pub. Date: Aug. 19, 2010

(54) CONTROL OF DEVICES BY WAY OF POWER WIRING

(76) Inventors: Verne Stephen Jackson, Maple Ridge (CA); Yohann Sulaiman, Vancouver (CA); Richard MacKellar, Garibaldi Highlands (CA); Jeanette Jackson, Port Moody (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/483,957

(22) Filed: Jun. 12, 2009

Related U.S. Application Data
(60) Provisional application No. 61/153,868, filed on Feb. 19, 2009.

(51) Int. Cl. G05B 11/01

(52) U.S. Cl. 340/310.11

(57) ABSTRACT

A system for controlling one or more devices through a power line comprises one or more control signal generators for generating control signal(s). Each control signal has a frequency within a predetermined frequency band and is injected onto the power line. A filter coupled between the power line and each device. Each filter is configured to pass signals within the corresponding frequency band to the device and block substantially all other signals, such that the device receives electrical power from the high frequency control signal.

### REFERENCE TO RELATED APPLICATION

This application claims the benefit of U.S. patent application No. 61/153,868 filed on 19 Feb. 2009 and entitled CONTROL OF DEVICES BY WAY OF POWER WIRING under 35 U.S.C. §119, which is hereby incorporated by reference herein.

### TECHNICAL FIELD

The invention relates to systems for controlling devices using power lines.

### SUMMARY

One aspect of the invention provides a system for controlling a device through a power line comprising a control signal generator for generating a control signal having a frequency within a predetermined frequency band and injecting the control signal onto the power line, and a filter coupled between the power line and the device. The filter is configured to pass signals within the predetermined frequency band to the device and block substantially all other signals, such that the device receives electrical power from the control signal.

Another aspect of the invention provides an apparatus comprising a filtering circuit connectible to a power line and an electrically powered device coupled to the filtering circuit. The filtering circuit is configured to pass only signals on the power line within a predetermined frequency band. The electrically powered device is configured to receive electrical power from a filtered signal passed by the filtering circuit.

Another aspect of the invention provides a method comprising generating a control signal within a predetermined frequency band, applying the control signal to a power line, filtering signals from the power line to pass only signals within the predetermined frequency band to provide a filtered signal to a device, and, powering the device with the filtered signal.

Further aspects of the invention and details of example embodiments are discussed below.

### BRIEF DESCRIPTION OF THE DRAWINGS

The accompanying drawings illustrate non-limiting example embodiments of the invention.

FIG. 1 is a block diagram schematically illustrating an example system according to one embodiment of the invention.

FIG. 2 is a block diagram schematically illustrating an example system according to another embodiment of the invention.

FIG. 3 schematically illustrates a system according to another embodiment of the invention applied to example household wiring.

FIG. 4 shows a universal controller according to another embodiment of the invention.

FIG. 5 shows an example lighting fixture according to another embodiment of the invention.

FIG. 6 shows an example remote control according to another embodiment of the invention.

FIG. 7 shows an example receptacle according to another embodiment of the invention.

FIG. 8 shows an example plug according to another embodiment of the invention.

FIGS. 9 and 10 show example controls according to other embodiments of the invention.

FIG. 11 shows an example system according to another embodiment of the invention wherein data is transmitted with the control signals.

FIG. 12 is a flowchart showing an example method according to one embodiment of the invention.

FIG. 13 shows an example system according to another embodiment of the invention wherein devices receive digital command signals from an ASIC.

FIG. 14 schematically illustrates example functional blocks of the ASIC of FIG. 13.

FIG. 15 shows an example system according to another embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Some embodiments of the invention provide systems for controlling devices using existing power line infrastructure. Relatively high frequency control signals are injected onto a power line by one or more control signal generators. Each control signal has a frequency or frequencies in a selected range or frequency band assigned to a particular device or set of devices to be controlled. Each device to be controlled is connected to the single power line through a filter which only passes control signals within the frequency band corresponding to that device. The control signals themselves provide power to the devices. The amplitudes of the control signals may control the operation of the devices. The devices may be kept turned on by applying the corresponding control signals, and may be turned off by discontinuing the control signals.

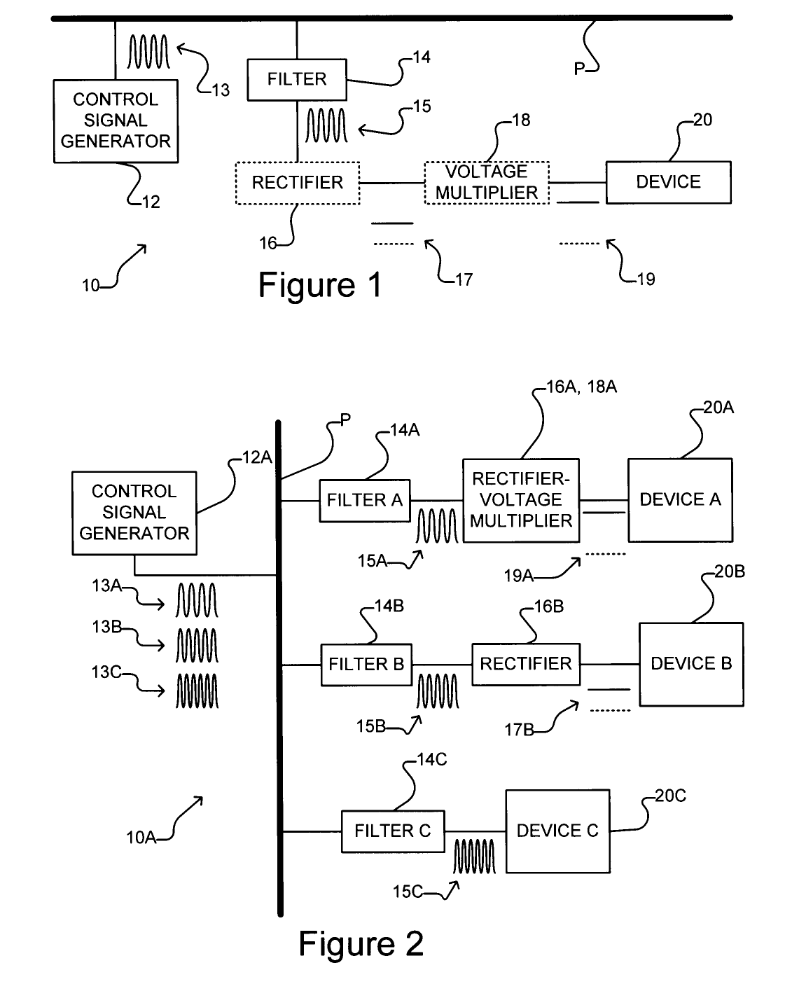

FIG. 1 schematically illustrates an example system 10 according to one embodiment of the invention. System 10 comprises a control signal generator 12 which is operable to control an electrically powered device 20 through a power line P. Power line P may comprise, for example, a wire of a building's existing power wiring which provides electrical power from a service panel or other power source (not shown) to various electrical fixtures in the building, such as a “hot” wire or a “neutral” wire. The electrical power provided by power line P may be, for example, AC power at 50 or 60 Hz.

Device 20 may comprise any electrical device, or any component thereof, which is configured to use electrical power in a format which may be provided by system 10, as described further below. For example and without limitation, device 20 may comprise a light fixture, a fan, a speaker, a camera, a relay which selectively connects another device to the power line, a billboard or other display, an infrared (IR) transmitter or transceiver, a radio-frequency (RF) transmitter or transceiver, a charger for another electrical device, a battery charger, etc.

Control signal generator 12 injects a control signal 13 onto power line P. Control signal 13 has a frequency within a predetermined range or “frequency band” which has been assigned for controlling device 20. Control signal 13 may have a relatively high frequency in comparison to the frequency of the AC power in power line P. For example, in some embodiments, the frequency of control signal 13 may exceed 1 kHz. Control signal generator 12 may be implemented on a chip in some embodiments, and may generate a control signal having a frequency exceeding 1 MHz, for example. In some embodiments, control signal 13 may have a frequency in the range of 10-100 MHz. The frequency of control signal 13 may be selected to avoid the frequency of the AC power in power line P (typically 50 or 60 Hz), and harmonics thereof.

Control signal generator 12 may comprise an oscillator in some embodiments. For example and without limitation, in some embodiments control signal generator 12 may comprise:
an LC oscillator;
an RC oscillator;
an Armstrong oscillator;
an autogenerator;
a blocking oscillator;
a Clapp oscillator;
a Colpitts oscillator;
a crystal-based oscillator;
a delay line oscillator;
a digitally-controlled oscillator;
a dynatron oscillator;
a frequency synthesizer;
a gated oscillator;
a Hartley oscillator;
an astable multivibrator;
a numerically-controlled oscillator;
an opto-electronic oscillator;
an oscillistor;
a parametric oscillator;
a phase-shift oscillator;
a Pierce oscillator;
a relaxation oscillator;
a ring oscillator;
a Robinson oscillator;
a Royer oscillator;
a sign oscillator;
a twin T oscillator;
a variable-frequency oscillator;
a Va\check{c}ká\check{r} oscillator;
a voltage-controlled oscillator;
a Wien bridge oscillator;
or other circuit configured to produce a periodic output signal.

Control signal 13 may have relatively low spectral purity and/or relatively high phase noise in some embodiments. Control signal 13 may have a mixture of several frequencies in some embodiments. Accordingly, control signal generator 12 may comprise a relatively low cost, low precision oscillator in some embodiments. Control signal generator 12 may, for example, comprise an integrated circuit having a built in oscillator. The characteristics of control signal generator 12 may be selected in conjunction with those of filter 14 in some embodiments, as described below.

The amplitude of control signal 13 is typically significantly lower than the voltage on power line P. The amplitude of control signal 13 may be adjustable. For example, in some embodiments the amplitude of control signal 13 may be in the range of 0 to 48V. Control signal 13 may have a maximum amplitude of 48V, 24V, 12V, 6V, 5V, or 3.3V in some embodiments, depending on the power requirements of device 20 to be controlled. The operation of device 20 may be controlled by varying the amplitude of control signal 13. As described further below, the amplitude of control signal may be selected to be higher than the maximum voltage required for device 20 such that any attenuation due to transmission of control signal 13 along power line P will not affect the operation of device 20.

Device 20 is coupled to power line P through a filter 14. Filter 14 is configured to allow signals having a frequency within a frequency range or band assigned to device 20 to pass therethrough, and to block substantially all other signals on power line P from reaching device 20. Filter 14 may comprise, for example, a bandpass filter having a pass band which includes the frequency of control signal 13. In some embodiments, filter 14 may comprise, for example, a high pass filter having a cutoff frequency lower than the frequency of control signal 13, in which case the frequency band has only a lower bound as determined by the cutoff frequency of the high pass filter. Filter 14 allows a filtered signal 15 corresponding to control signal 13 to pass therethrough. Filtered signal 15 provides the electrical power to be used by device 20. Filtered signal 15 may have a frequency and an amplitude equal to the frequency and amplitude of control signal 13 in some embodiments.

Filter 14 may comprise a passive filter, an active filter or a hybrid filter. For example and without limitation, in some embodiments filter 14 may comprise:
an RC filter;
an RL filter;
an LC filter;
an RLC filter;
a Sallen-Key filter;
a voltage-controlled voltage-source (VCVS)filter;
a Butterworth filter;
a Chebyshev filter;
a Bessel (or Thompson) filter;
a Gaussian filter;
or another circuit configured to pass signals within a desired frequency range and attenuate other signals.

Filter 14 may be constructed from relatively low cost components, as a narrow pass band and stable filtering are not required in some embodiments. Filter 14 may comprise a broadband filter in some embodiments. Filter 14 may have a relatively low Q-factor in some embodiments. Filter 14 may provide relatively lossy filtering, and may allow some spread or distortion of control signal 13, while allowing the bulk of the signal to pass therethrough. The range of frequencies passed by filter 14 may be selected based on the frequency or frequencies of control signal 13 generated by control signal generator 12.

The amplitude of filtered signal 15 may determine the operation of device 20 in some embodiments. For example, device 20 may be operable to produce different responses when provided with electrical power at different voltages. The amplitude of control signal 13 may determine the amplitude of filtered signal 15, and thus the voltage provided to device 20. The operation of device 20 may thus be controlled by altering the amplitude of control signal 13. For example, the amplitude of control signal 13 may control:
the brightness of a light;
the colour of a light;
the volume of a speaker;
the orientation of a camera;
the transmission of IR of RF signals for controlling consumer electronics;
the sound emitted by a doorbell;
the operation of a battery charger;
the operation of a billboard or other electrically powered display;
etc.

Control signal 13 may be generated continuously while device 20 is in operation. Since control signal 13 provides the electrical power used by device 20, in some embodiments device 20 operates as long a control signal 13 is present. System 10 is thus robust and resistant to any noise or interference on power line P. Even if a control signal 13 is momentarily obscured by other signals on power line P, control of device 20 will be substantially unaffected.

A rectifier 16 may be provided in some embodiments where device 20 uses DC power. Rectifier 16 receives filtered signal 15 from filter 14 and outputs a rectified DC signal 17. In other embodiments, rectifier 16 may be omitted, such as for example where device 20 is configured to use AC power having a frequency equal to that of filtered signal 15.

A voltage multiplier 18 may be provided in some embodiments to adjust the voltage of the electrical power provided to device 20. Voltage multiplier receives rectified DC signal 17 from rectifier 16 and outputs a multiplied DC signal 19. Voltage multiplier 18 may be useful in some embodiments for providing device 20 with DC power having a voltage range which is larger than a range of amplitudes for control signal 13 generated by control signal generator 12. In other embodiments, voltage multiplier 18 may be omitted. In other embodiments, a voltage regulator (not shown) may be provided to put an upper limit on the voltage provided to device 20.

In some embodiments, the rectifying and voltage multiplying functions of rectifier 16 and voltage multiplier 18 may be performed by the same circuit. In other embodiments, filter 14 and/or device 20 may include circuitry for performing any desired rectifying and/or voltage multiplying. Also, in some embodiments, in addition to receiving power from control signal 13, device 20 may receive standard AC power from power line P.

In some embodiments, filter 14, rectifier 16 and/or voltage multiplier 18 may be wholly or partially implemented on a chip such as, for example, an application-specific integrated circuit (ASIC). One or more discrete components, such as capacitors, resistors and/or inductors may also be provided in conjunction with an ASIC in some embodiments, to adjust the pass band or other filtering characteristics achievable by filter 14.

FIG. 2 schematically illustrates an example system 10A according to one embodiment of the invention. System 10A comprises a control signal generator 12A which is operable to control a plurality of devices 20A, 20B, 20C through power line P. Three devices are shown in FIG. 2, but it is to be understood that any practical number of devices could be controlled by control signal generator 12A. Also, instead of a single control signal generator 12A as illustrated in the FIG. 2 embodiment, multiple control signal generators could be provided.

Control signal generator 12A is configured to generate a plurality of high frequency AC control signals 13A, 13B, 13C. Control signal generator 12A may comprise a mixer for combining control signals 13A, 13B, 13C. The frequency of each control signal 13A, 13B, 13C is selected to be within a predetermined frequency range which has been assigned to the respective device 20A, 20B, 20C to be controlled. Control signal generator 12A applies control signals 13A, 13B, 13C to power line P.

The frequency bands may be selected such that there is a gap between successive bands. For example, the frequency bands may be selected to be 10-20 MHz, 30-40 MHz, 50-60 MHz, etc. in some embodiments. Different frequency bands may be selected in different embodiments. The frequency bands have equal sizes in some embodiments, or the sizes of different bands may be different. The frequency bands may be equally spaced in some embodiments, or the spacing may be different between different bands. The frequency bands may be selected based on capacitors available for filtering in some embodiments, such as, for example, where the filters are to be implemented on chips. The frequency bands may all fall between about 1 kHz and about 100 MHz in some embodiments. Control signals 13A, 13B, 13C are preferably selected such that any interference or “beat” patterns do not have frequencies lying within any of the frequency bands assigned to devices 20A, 20B, 20C.

Each device 20A, 20B, 20C is coupled to power line P through a corresponding filter 14A, 14B, 14C configured to pass only signals having frequencies within the frequency band assigned to the respective device 20A, 20B, 20C. Filters 14A, 14B, 14C thus pass filtered signals 15A, 15B, 15C corresponding to control signals 13A, 13B, 13C therethrough. Filtered signals 15A, 15B, 15C may each have a frequency and an amplitude equal to the frequency and amplitude of the corresponding control signal 13A, 13B, 13C in some embodiments. Filtered signals 15A, 15B, 15C provide electrical power to devices 20A, 20B, 20C.

Other elements may also be connected between filters 14A, 14B, 14C and devices 20A, 20B, 20C to process filtered signals 15A, 15B, 15C for use by devices 20A, 20B, 20C. For example, device 20A is connected to filter 14A through a combined rectifier-voltage multiplier 16A, 18A. Rectifier-voltage multiplier 16A, 18A produces a multiplied DC signal 19A for use by device 20A. Device 20B is connected to filter 14B through a rectifier 16B. Rectifier 16B produces a rectified DC signal 17B for use by device 20B. Device 20C is connected directly to filter 14C. Device 20C is configured to use filtered signal 15C.

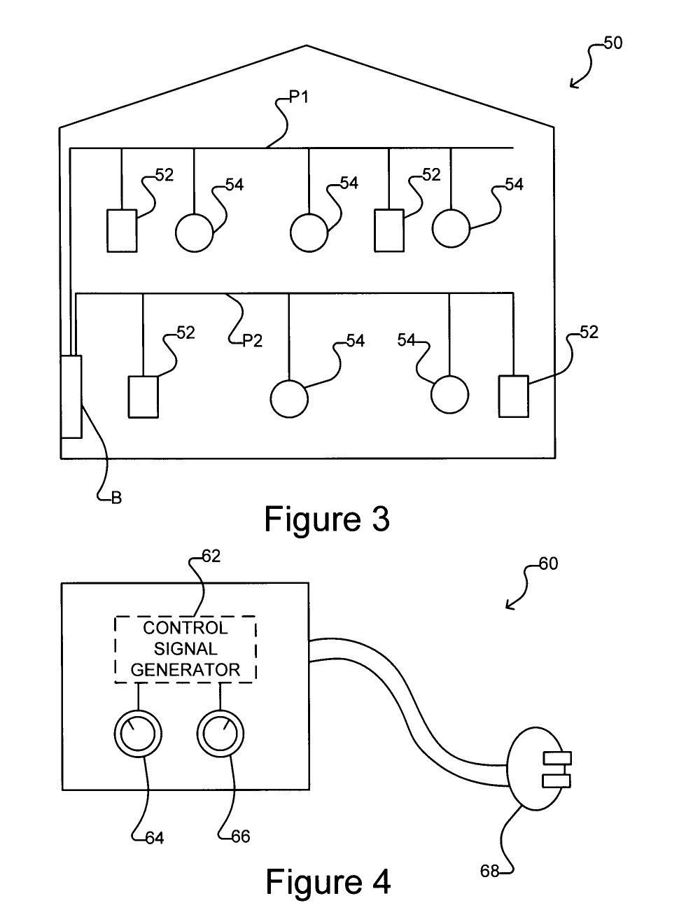

FIG. 3 shows an example system 50 according to one embodiment of the invention applied to example household wiring. System 50 comprises a plurality of controls 52 and a plurality of devices 54 connected to first and second power lines P1 and P2 in the form of “hot” wires of first and second circuits of existing household wiring. Each control 52 may comprise an integrated circuit which generates control signals within a frequency band assigned to one or more devices 54. Each device 54 may comprise an integrated circuit which filters out signals outside of an assigned frequency band, such that the device 54 may be powered by control signals within the assigned frequency band. In some embodiments, a plurality of devices 54 may receive control signals from a single control 52.

In order to compensate for attenuation of control signals as they travel along power line P1 or P2, the amplitudes of the control signals may be greater than the upper limit of the voltages to be used by devices 54 in some embodiments. In such embodiments a device 54 may be coupled to power lines P1 through a voltage regulator which limits the voltage provided to that device 54. For example, a particular device 54 may have a maximum input voltage which is 90% of the maximum amplitude of the control signal, such that the device 54 receives the maximum input voltage when the control signal is generated at or near its maximum amplitude, despite some attenuation of the control signal as it travels along the power line. In such embodiments, reducing the amplitude of the control signal from the maximum amplitude initially produces no change in the voltage provided to device 54, until the received amplitude (which may be slightly attenuated) drops below 90% of the maximum amplitude, after which point reducing the amplitude of the control signal produces a corresponding reduction in the voltage provided to device 54.

In the illustrated embodiment, power lines P1 and P2 are each connected to a household electrical distribution box B. The control signals may be substantially attenuated by breakers and/or fuses in box B. Also, in some embodiments, low pass filters having cutoff frequencies below the frequencies of the control signals may be provided to isolate sections of power lines.

FIG. 4 shows a universal controller 60 according to another embodiment of the invention. Controller 60 comprises a control signal generator 62 operably connected to a device selector 64 and a level selector 66. Device selector 64 may be used to select one of a plurality of devices. Controller 60 causes control signal generator 62 to generate control signals within a frequency band assigned to device currently selected by device selector 64. Level selector 66 may be used to vary the amplitude of the control signals generated by control signal generator 62. In some embodiments, a plug 68 may be coupled to control signal generator 62. Control signals generated by control signal generator 62 may be sent over a power line (not shown) by inserting plug 68 into an electrical receptacle. In other embodiments, controller 60 may have a “hard-wired” connection to the power line.

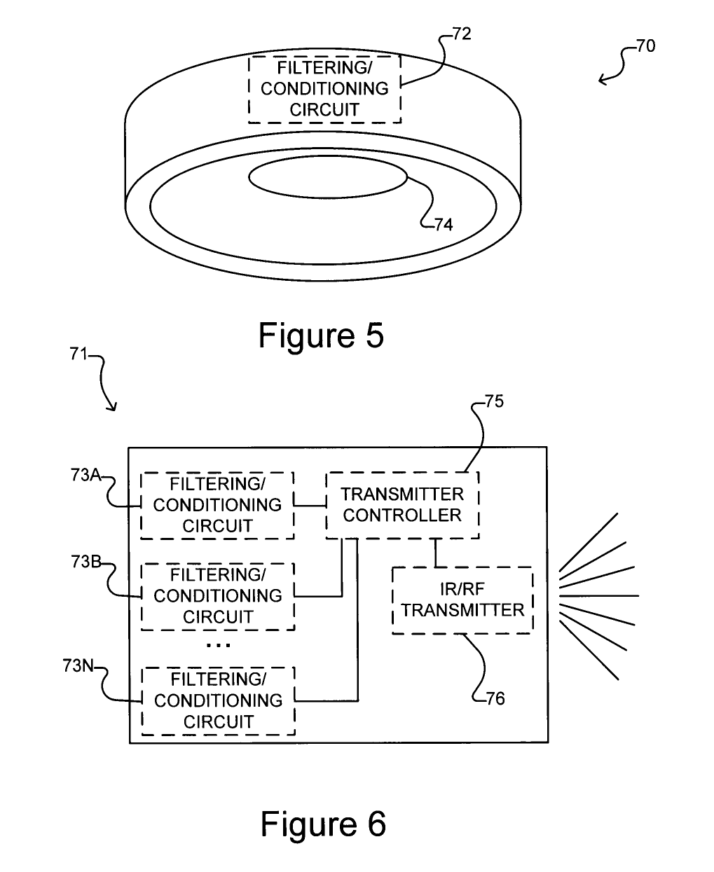

FIG. 5 shows an example lighting fixture 70 according to another embodiment of the invention. Lighting fixture 70 comprises a filtering and conditioning circuit 72 coupled between a light source 74 and a power line (not shown). Circuit 72 is configured to allow only control signals within a frequency band assigned to lighting fixture 70 to pass, and conditions such control signals to provide electrical power in a format suitable for use by light source 74. Light source 74 may comprise, for example, a LED or other sort of low voltage light source.

FIG. 6 shows an example remote control 71 according to another embodiment of the invention for controlling a consumer electronic device (not shown). Remote control 71 comprises a plurality of filtering and conditioning circuits 73A-N coupled between a power line (not shown) and a transmitter controller 75, which is in turn coupled to an IR or RF transmitter 76. Each of the filtering and conditioning circuits 73A-N corresponds to a different remote control command to be sent by transmitter 76, and configured to allow only signals within a frequency band assigned to that remote control command to pass. The remote control commands may comprise, for example, volume up, volume down, channel up, channel down, play, pause, etc., depending on the type of consumer electronic device to be controlled by remote control 71. Upon receipt of a control signal within the frequency band assigned to a particular remote control command, the corresponding one of the filtering and conditioning circuits 73A-N passes and conditions that control signal for powering transmitter controller 75, which causes transmitter 76 to emit the specified remote control command to the consumer electronic device.

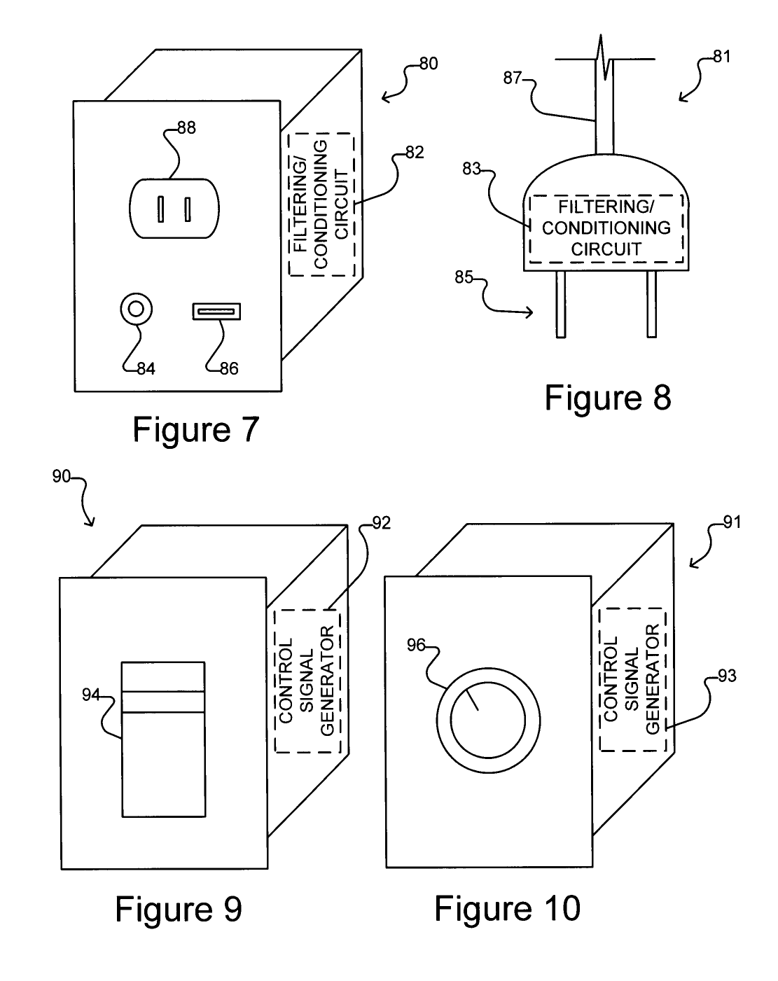

FIG. 7 shows an example receptacle 80 according to another embodiment of the invention. Receptacle 80 comprises a filtering and conditioning circuit 82 coupled between DC sockets 84, 86 and a power line (not shown). Circuit 82 is configured to pass only control signals within a frequency band assigned to receptacle 80, and to condition such control signals to provide DC electrical power at desired voltages for DC sockets 84 and 86. Receptacle 80 may also comprise an AC socket 88, which may either be coupled directly to the power line to receive standard AC power, or may be coupled to the power line through circuit 82 to be powered directly by the control signals. AC socket 88 may comprise, for example, a socket with dimensions complying with ANSI/NEMA WD 6-2002 (R2008) or other standards.

FIG. 8 shows an example plug 81 according to another embodiment of the invention. Plug 81 comprises a filtering and conditioning circuit 83 coupled between a prong 85 which is connectible to a power line (not shown) by insertion into a receptacle (not shown), and a wire within a cord 87 which is connected to a corresponding device (not shown). Circuit 83 is configured to pass only control signals within a frequency band assigned to the corresponding device, and to condition such control signals to provide electrical power in a suitable format to the corresponding device through cord 87. Since the power provided by the control signals is generally of a relatively low voltage as compared to the voltage of standard AC power on the power line, the risk of harm associated with damage to cord 87 is greatly reduced. Plug 81 may advantageously be attached to a device configured to use DC power in some embodiments, thereby eliminating the need for relatively bulky transformers which are often built into prior art plugs used with DC devices. Plug 81 may comprise, for example, a plug with dimensions complying with ANSI/NEMA WD 6-2002 (R2008) or other standards.

FIGS. 9 and 10 show example controls 90 and 91 according to other embodiments of the invention. Each of controls 90, 91 comprises a control signal generator 92, 93 connected to apply control signals within a frequency band assigned to a particular device to a power line (not shown). Control 90 comprises a slider 94 operably connected to control signal generator 92 to vary the amplitude of the control signals generated by control signal generator 92. Control 91 comprises a knob 96 operably connected to control signal generator 93 to vary the amplitude of the control signals generated by control signal generator 93.

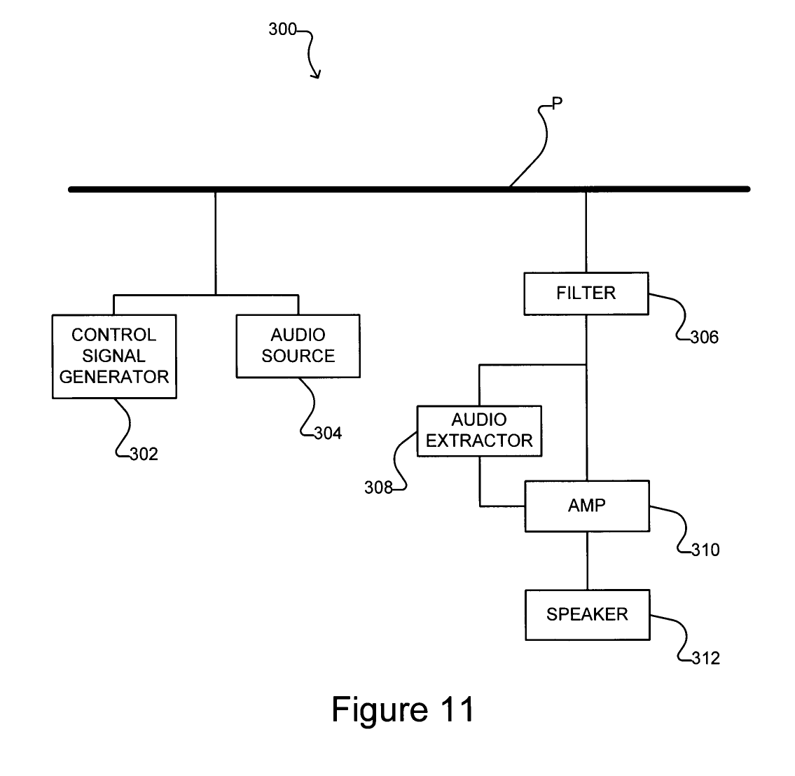

FIG. 11 shows a system 300 according to another embodiment of the invention. System 300 comprises a control signal generator 302 which injects control signals within a predetermined frequency band as described above onto power line P. An audio source 304 adds audio data to the control signals. For example, audio source 304 may apply frequency modulation within the frequency band to the control signals. A filter 306 coupled to power line P is configured to pass only signals within the frequency band. The filtered signals are provided to an audio extractor 308, and also used to power an amplifier 310. Audio extractor 308 extracts audio data from the filtered signals and provides the audio data to amplifier 310, which in turn drives a speaker 312 to output the audio.

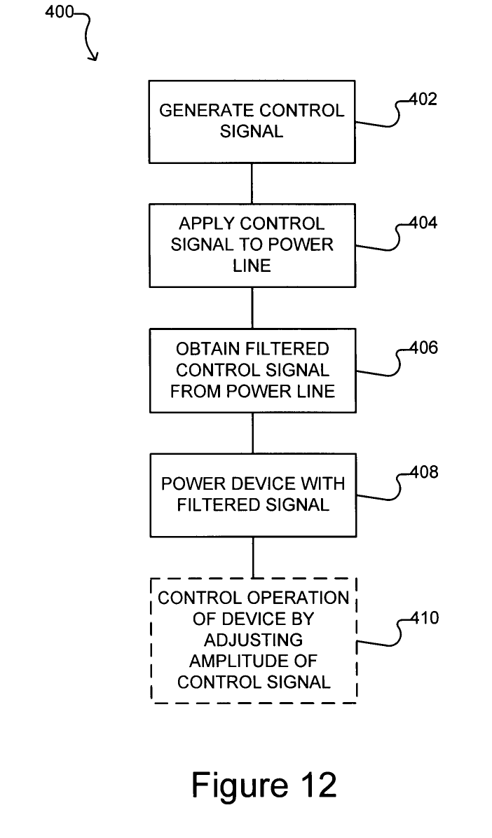

FIG. 12 shows a method 400 according to one embodiment of the invention. At block 402 a control signal is generated within a predetermined frequency band assigned to a device. At block 404 the control signal is applied to a power line. At block 406 a filtered signal is obtained from the power line by passing only signals within the frequency band. At block 408 the device receives power from the filtered signal. At block 410 the operation of the device may optionally be controlled by adjusting the amplitude of the control signal.

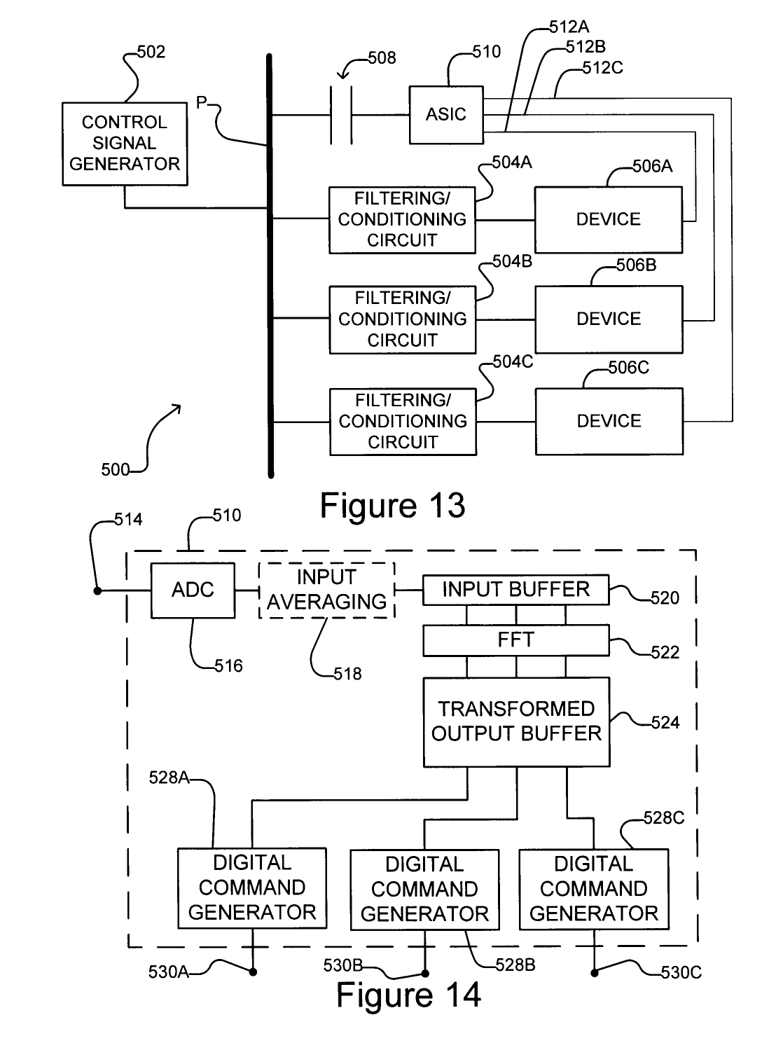

FIG. 13 shows a system 500 according to another embodiment of the invention. System 500 comprises a control signal generator 502 which injects control signals within predetermined frequency bands onto power line P, as described above. Each filtering and conditioning circuit 504A, 504B, 504C is configured to supply the corresponding device 506A, 506B, 506C with electrical power when signals within a particular frequency band assigned to the corresponding device 506A, 506B, 506C is present on power line P, as also described above. System 500 also comprises a capacitor 508 which provides AC isolation for an application specific integrated circuit (ASIC) 510. In some embodiments, ASIC 510 may comprise a System-on-a-chip (SoC), including a processor and memory integrated into a single chip.

ASIC 510 receives analog AC signals from power line P through capacitor 508, and generates digital command signals which are provided to devices 506A, 506B and 506C through digital control lines 512A, 512B and 512C, respectively. The digital command signals generated by ASIC 510 may conform to one or more standardized communications protocols, such as, for example, BACnet or DMX512-A, depending on the characteristics of devices 506A, 506B and 506C. The digital command signals generated by ASIC 510 may specify commands of varying complexity, depending on types of devices 506A, 506B and 506C.

ASIC 510 may generate digital command signals for one or more of devices 506A, 506B and 506C in response to the presence of a control signal on power line P within a single predetermined command frequency band. For example, a control signal on power line P within a first frequency band could cause ASIC 510 to generate digital command signals to turn on a television and main lighting, and a control signal within a second command frequency band could cause ASIC 510 to generate digital command signals to turn off the television and main lighting, and turn on pool lighting. ASIC 510 may thus be programmed to generate any desired combination of digital command signals in response to a control signal within a particular command frequency band by mapping each command frequency band to the desired digital command signal(s). The command frequency bands which cause ASIC 510 to generate digital command signals may be different from the frequency bands assigned for providing electrical power to devices 506A, 506B and 506C.

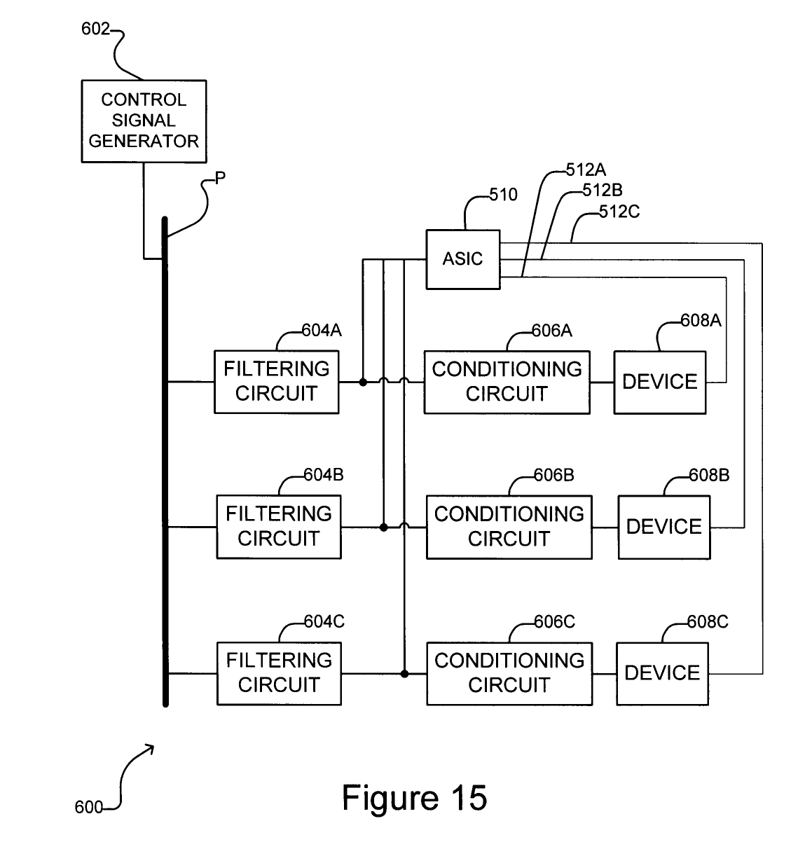

In some embodiments, instead of being coupled to power line P, ASIC 510 may be coupled between the power filtering circuits and the corresponding devices. For example, FIG. 15 shows a system 600 wherein a control signal generator 602 injects control signals onto power line P, filtering circuits 604A, 604B and 604C allow signals within particular frequency bands to pass to conditioning circuits 606A, 606B and 606C, which condition the filtered signals to supply the corresponding devices 608A, 608B and 608C with electrical power in a suitable format, as described above. In system 600, the input of ASIC 510 is connected to wires extending between filtering circuits 604A, 604B and 604C and the corresponding conditioning circuits 606A, 606B and 606C. In such embodiments, the command frequency bands may be within the frequency bands assigned for providing electrical power to devices 608A, 608B and 608C, and the frequencies of the control signals for generating digital command signals could be slightly offset from the frequencies of the control signals for powering devices 608A, 608B and 608C. ASIC 510 may comprise a filter for attenuating the frequencies of the control signals for powering devices 608A, 608B and 608C in such embodiments.

FIG. 14 schematically illustrates functional blocks of an example ASIC 510. An input 514 receives analog AC signals and passes them to an analog-to-digital converter (ADC) 516. ADC 516 samples the analog input signal to produce a digital signal. In some embodiments, ADC 516 may have a voltage measurement range of 0-5V, a resolution of 12 bits, and a sampling rate of 20 kHz, for example. In some embodiments, ASIC 510 is configured to monitor command frequency bands ranging from 1-10 kHz. The command frequency bands may be centered on frequencies separated by intervals of 600 Hz, 1200 Hz or 2400 Hz, for example. Suitable bandpass filtering may be provided to permit undersampling of higher frequency control signals and avoid aliasing in some embodiments. Loss of information due to undersampling is not a concern, since ASIC 510 typically only needs to determine the presence of frequencies within particular frequency bands, and reconstruction of the control signals is not required.

The digital signal from ADC 516 may optionally be passed to an input averaging block 518 for filtering out noise from the digital signal in some embodiments. Input averaging block 518 may comprise, for example, one or more digital filters such as a moving average filter, or the like.

The digital signal is provided to an input buffer 520 and then to an FFT block 522, which performs a fast Fourier transform to convert the digital signal from the time domain into the frequency domain. The frequency domain signal is then provided to a transformed output buffer 524.

The frequency domain signal is provided to a plurality of digital command generators 528A, 528B and 528C. Each digital command generator 528A, 528B, 528C is associated with a corresponding one of devices 506A, 506B, 506C, and is configured to check the frequency domain signal for the presence of frequencies within a predetermined command frequency band which has been selected to produce a digital command signal for the corresponding device. Digital command generators 528A, 528B and 528C may determine the presence of frequencies withing a particular command frequency band, for example, by determining if the power of frequencies within that band exceeds a predetermined threshold. If frequencies within a particular command frequency band are present, digital command generators 528A, 528B, 528C generate one or more digital command signals which have been selected for that command frequency band. Digital command generators 528A, 528B and 528C provides the digital command signals to outputs 530A, 530B and 530C, which are respectively connected to digital control lines 512A, 512B and 512C.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A system for controlling a device through a power line, the system comprising:
a control signal generator for generating a control signal having a frequency within a predetermined frequency band and injecting the control signal onto the power line;
a filter coupled between the single power line and the device, the filter configured to pass signals within the predetermined frequency band to the device and block substantially all other signals, such that the device receives electrical power from the control signal.

2. A system according to claim 1 wherein the control signal generator is configured to generate a plurality of control signals for controlling a plurality of devices, each of the plurality of control signals having a frequency within a different predetermined frequency band, each frequency band corresponding to one of the plurality of devices.

3. A system according to claim 2 comprising a plurality of filters, each filter coupled between a respective one of the plurality of devices and the single power line and configured to pass signals within the corresponding frequency band to the respective device and block substantially all other signals, such that the devices receive electrical power from the control signals.

4. A system according to claim 3 wherein each predetermined frequency band has a range of approximately 10 MHz.

5. A system according to claim 1 wherein the frequency of the control signal is at least 1 kHz.

6. A system according to claim 1 comprising a rectifier coupled between the filter and the device.

7. A system according to claim 6 comprising a voltage multiplier coupled between the rectifier and the device.

8. A system according to claim 1 wherein the control signal generator is configured to selectively adjust an amplitude of the control signal to control operating characteristics of the device.

9. A system according to claim 8 wherein the device comprises a light and adjusting the amplitude of the control signal adjusts a brightness of the light.

10. A system according to claim 8 wherein the device comprises a light and adjusting the amplitude of the control signal adjusts a colour of the light.

11. A system according to claim 8 wherein the device comprises a speaker and adjusting the amplitude of the control signal adjusts a volume of the speaker.

12. A system according to claim 8 wherein the device comprises a camera and adjusting the amplitude of the control signal adjusts an orientation of the camera.

13. A system according to claim 8 wherein the device comprises a remote control and adjusting the amplitude of the control signal adjusts a remote control command transmitted by the remote control.

14. A system according to claim 8 wherein the device comprises a charger and adjusting the amplitude of the control signal adjusts a charging voltage of the charger.

15. A system according to claim 8 wherein the device comprises an electrically powered display operable to display one of a plurality of display packages and adjusting the amplitude of the control signal adjusts the display package to be displayed.

16. A system according to claim 3 comprising an application specific integrated circuit configured to generate one or more digital command signals in response to a control signal on the power line within a predetermined command frequency band.

17. A system according to claim 16 wherein the application specific integrated circuit comprises an analog to digital converter and a moving average filter.

18. A system according to claim 17 wherein the application specific integrated circuit is configured to perform a fast Fourier transformation on an output of the moving average filter to produce a frequency domain signal.

19. A system according to claim 18 wherein the application specific integrated circuit is configured to determine the presence of a control signal within the predetermined command frequency band by comparing the power of the frequency domain signal within the predetermined command frequency band with a predetermined threshold.

20. A method comprising:
generating a control signal within a predetermined frequency band;
applying the control signal to a power line;
filtering signals from the power line to pass only signals within the predetermined frequency band to provide a filtered signal to a device; and,
powering the device with the filtered signal.

21. A method according to claim 20 wherein generating the control signal comprises generating a plurality of control signals having frequencies within different predetermined frequency bands, and wherein filtering signals comprises passing signals within each of the different predetermined frequency bands to provide a corresponding filtered signal to a corresponding one of a plurality of devices.

22. A method according to claim 20 wherein generating the control signal comprises selectively adjusting an amplitude of the control signal to control operating characteristics of the device.

23. An apparatus comprising:
a filtering circuit connectible to a power line, the filtering circuit configured to pass only signals on the power line within a predetermined frequency band; and,
an electrically powered device coupled to the filtering circuit, the electrically powered device configured to receive electrical power from a filtered signal passed by the filtering circuit.
